(19) United States
(12) Patent Application Publication
(10) Pub. No.: US 2010/0162830 A1
(43) Pub. Date: Jul. 1, 2010

(54) Torque-measuring flange

(76) Inventors: Herbert Meuter, Herzogenrath (DE); Michael Koslowski, Herzogenrath (DE); Ralf Lanfermann, Aachen (DE)

Correspondence Address: COLLARD & ROE, P.C., 1077 NORTHERN BOULEVARD, ROSLYN, NY, 11576, US

(21) Appl. No.: 12/308,287

(22) PCT Filed: Jun. 14, 2007
(86) PCT No.: PCT/DE2007/001073

§ 371 Date: Jan. 23, 2009

(30) Foreign Application Priority Data
Jun. 14, 2006 (DE) 10 2006 027 967.0
Feb. 1, 2007 (DE) 10 2007 005 894.4

(51) Int. Cl. G01L 3/14

(52) U.S. Cl. 73/862.321

(57) ABSTRACT

A torque-sensing flange, or generally a torque measurement recorder, is proposed, which has differently embodied measurement recesses or differently embodied measuring diaphragms on an essentially cylindrical measuring range. Different measuring ranges can be easily achieved in this manner.

The invention relates to a torque-measuring flange.

Measuring constant or dynamic torques is a routine task encountered in numerous areas of technology. A plurality of known torques-sensing flanges, also referred to generally as torque measuring transducers, exists to cover the various applications, installation conditions and precision requirements.

DE 199 36 293 depicts a torque-measuring flange, in which an essentially cylindrical hollow shaft segment is situated between two annularly circular coupling flanges. This hollow shaft segment makes up the measuring range of the torque-measuring flange. The essentially cylindrical wall incorporates three large measurement recesses, thereby yielding three measuring diaphragms on the cylindrical inner wall. An introduced torque can give rise to relatively large deformations given the relatively slight wall thickness of the measuring diaphragm, so that expansion-measuring strips applied thereto permit the relatively accurate calculation of the applied torque. For smaller torques, the measuring diaphragm can be situated radially inward. For larger torques to be measured, the diaphragm can be situated radially outward. The publication also proposes that the pocket-shaped recesses be arranged opposite each other, thereby yielding an H-profile, or that the recesses radially alternate, so that they alternatingly proceed from the inner followed by the outer jacket surface of the cylinder form.

Other torque-measuring transducers are known from DE 100 55 933 A1, DE 198 26 629 A1, DE 44 12 377 A1, DE 195 25 231 B4, DE 42 08 522 C2, EP 0 465 881 A2 and EP 0 575 634 A 1.

The object of the invention is to provide an improved torque-measuring flange.

In a first aspect of the invention, this object is achieved by means of a torque-measuring flange with an essentially cylindrical measuring range, in which measuring recesses are situated, and by means of measured value transducers, which measure stresses and/or deformations in the measuring range, wherein at least two measuring recesses are shaped and/or embodied differently.

With respect to terminology, let it first be explained that the “measuring range” is regarded as the range of the entire measured value transducer formed between the two flange-like connection areas, and non-positively connects them with each other. For example, when a torque is applied to the two connection areas on a machine or test bench, meaning in particular to the two flanges, the measuring range is also subjected to that torque. The measuring range is usually circularly, annularly circular or at least essentially circular or annularly circular in cross section, perpendicular to the axis around which the torque is acting. Annularly circularly cross sections are most often encountered.

The “measuring recesses” are incorporated into the radially outward jacket surface and/or the radially inward jacket surface as recesses.

The introduced aspect of the invention is characterized in that it forms and/or embodies two such measuring recesses differently. These can be both radially inward recesses with a different shaped, and radially outward recesses, if radially inward and radially outward recesses are present in the measuring range. In particular, however, let it be imagined that radially outward recesses of varying shape are visible inside the family of radially inward recesses and/or inside the family of radially outward recesses.

As a result of the various shapes of the recesses, a torque applied to the measuring points of the individual, different measuring recesses triggers varying deformations and/or stresses, thereby making it possible, for example, for a single torque measuring-flange to enable several more highly resolved or several varyingly resolved measuring ranges.

It is preferred for at least two measuring recesses exhibit different depths. Providing different measuring recesses with varying depths, in particular within a family of radially inward and/or a family of radially outward measuring recesses, generates varying expansions and stresses in the remaining floors radially outward or radially inward of the recesses, meaning in the measuring diaphragms, given a suitable design.

Two measuring recesses preferably exhibit a different cross section. With respect to terminology, let it first be explained that the “cross section” of a recess is to be understood in particular as the surface that forms in a cutting plane perpendicular to the axis of the torque-measuring flange between the material limits of the recesses and a circular, smallest peripheral as the free surface. Specifically, a cut perpendicular to the axis of the torque-measuring flange will yield a cutting geometry at a measuring recess that has at least two lateral edges from ed by the at least essentially massive cylinder wall, and that might exhibit a floor radially inward or radially outward, i.e., basically a measuring diaphragm, wherein the lateral edges can run radially in the simplest case. The remaining free surface of the recess within these limits and a circular peripheral outside and/or inside on the cylindrical measuring range would then be regarded as the cross section of the measuring recess.

As an alternative, the “cross section” can be taken as the resultant free surface that arises given a cut with a plane parallel to the axis of the torque-measuring flange, or the “cross section” can be taken as the resultant free surface that arises given a cut with a cylindrical jacket surface around the axis of the torque-measuring flange during its development.

If two measuring recesses exhibit a different cross section, an applied torque triggers a varying expansion and/or stress distribution, at least at one edge area of the recess, so that measurements can here also be readily performed for measuring areas resolved to varying degrees.

At least essentially uniformly embodied measuring recesses are preferably arranged symmetrically relative to a rotational axis of the torque flange, in particular rotationally symmetrically. Given a suitable design, the same tension and/or expansion behavior can as a result be expected at the measuring points on a family of identical or identically embodied measuring recesses, especially if all measuring recesses at the torque-measuring flange belong to a respective family of identical and symmetrically distributed recesses.

At least one measuring recess preferably exhibits an at least essentially partially cylindrical recess floor.

With respect to terminology, the above will be explained as follows: The torque-measuring flange has a longitudinal axis, around which the applied torques are to be measured. An outer cylindrical jacket surface around this axis can be imagined, which represents the smallest peripheral of the at least essentially cylindrical measuring range. As a rule, the measuring range will be designed cylindrical radially outward, so that the cylinder jacket surface of the cylindrical measuring range precisely corresponds to its radially outward surface. Radially outward measuring recesses extend radially inward from the cylinder jacket surface, wherein each measuring recess has a recess wall and recess floor, although the latter can converge without any clear seam. A “partially cylindrical recess floor” is on hand when the measuring recess at least partially exhibits a surface that is spatially bent in such a way as to represent a part of an imagined cylinder jacket surface. Possibilities include in particular an imagined cylinder, which has the axis of the torque-measuring flange as the cylinder axis, wherein its radius given a radially outward measuring recess is smaller than that of the peripheral cylinder jacket surface of the measuring range. Especially possible as a variant is an imagined cylinder with an axis lying parallel to the axis of the torque-measuring flange, but between its axis and its outer peripheral jacket surface.

A highly precise conversion between the measured expansion and/or stress conditions on a partially cylindrical surface on the recess floor or on a recess wall can be performed to derive the torque applied to the torque-measuring flange.

It is understood that a partially cylindrical recess floor can also be present given a radially inward measuring recess.

In addition to an essentially partially cylindrical recess floor, it is proposed that at least one measuring recess exhibit a recess floor that deviates from a cylinder form, in particular a flat recess floor. It is understood that a very precise conversion between expansion and/or stress and the applied torque to be measured is also possible on a flat recess floor. In addition, the measuring strips are easy to permanently secure to a plane.

It is understood that a measuring recess can deviate to nearly whatever depth from the outer or inner peripheral of the cylindrical measuring range. It is proposed that at least one measuring recess exhibit a recess floor with a surface corresponding to the surface of the cylindrical measuring range toward which the measuring recess is oriented. In other words, a recess is designed with such a depth that the radial thickness of the cylinder in the measuring range is almost completely traversed by the measuring recess, so that a radially outward measuring recess runs nearly to the inner cylinder surface of the measuring range, or that a radially inward measuring recess runs nearly to the outer cylinder jacket of the measuring range. However, the recess is not or at least not completely embodied as a penetration area between the inward and outward cylinder jacket surface, but remains a thin diaphragm. This diaphragm is both the recess floor of the measuring recess when viewed from the one radial side and the cylinder jacket shaped surface of the measuring range, specifically radially inward or radially outward, when viewed from the other radial direction.

A reduction in the measuring diaphragm, meaning the remaining material below the recess floor of a measuring recess, to a rather thin surface results in an enhanced reproduction of an applied torque, since the expansion and stress are strengthened. This enables a highly resolved measurement of torque.

It is preferred that at least one measuring recess exhibit a round cross section.

To this end, let the following terminological explanation be provided: A “round” cross second is understood in particular as a circular cross section. However, an expanded consideration also makes it possible to interpret “round” as being any other cross section free of corners, and preferably also free of straight lines. The “cross section” of the measuring recess is viewed in particular in a cutting plane, which lies perpendicular to the longitudinal axis of the torque-measuring flange. The word “cross section” can be expanded to include the winding of an interface on an imagined cylinder jacket surface around the longitudinal axis of the torque-measuring flange. Also possible is a cutting plane lying parallel to the longitudinal axis of the torque-measuring flange.

Imagined in particular is a borehole with a circular cross section given a section parallel to the longitudinal axis of the torque-measuring flange, wherein the borehole forms the measuring recess, preferably with a borehole axis directed radially to the longitudinal axis of the torque-measuring flange.

Also advantageously possible from a cumulative standpoint is for at least one measuring recess to exhibit a rectangular cross-section with rounded corners, in particular a square cross section with rounded corners.

Both a measuring recess with a round cross section and a measuring recess with a rectangular, even square, cross section with rounded corners can be relatively easily incorporated into the measuring range, and results in relatively well known force redistributions during exposure to a torque to be measured.

It is proposed that each measuring recess provide a measured value transducer. It is viewed as advantageous at the very least for each measuring recess to exhibit a varying form per measured value transducer.

The provision of several measured value transducers, e.g., expansion measuring strips, makes it possible to verify measured values, for example, or the different measured values can be averaged. It is also conceivable that the different measured value transducers can measure specific torque ranges with varying resolution levels, precisely when two identical or different measured value transducers are arranged in varyingly designed and/or embodied measuring recesses.

As was already explained, at least one measuring recess can open radially inward. In such a measuring recess, the recess floor lies radially outward, so that the measured value transducers can preferably be arranged there.

It is proposed that the cross section of at least one measuring recess change starting from the recess floor, preferably expand or narrow.

In a second aspect of the invention, the object is achieved by means of a torque-measuring flange with a measuring range situated around a rotational axis, which incorporates measuring diaphragms, and with measured value transducers, which measure stresses and/or deformations of the measuring diaphragms, wherein at least two measuring diaphragms are differently shaped and/or embodied.

As already explained from a terminological standpoint, “measuring diaphragms” are flat segments thinner in design by comparison to the remaining cylindrical area. Torques applied to the torque-measuring flange can be amplified and measured on these thin flat segments and/or around these thin flat segments, so that very precise results can be obtained.

It is proposed that at least two measuring diaphragms exhibit a different thickness.

The “thickness” of a measuring diaphragm is regarded as the radial thickness. The latter is often also referred to as “material thickness”.

Already the varying material thickness of the membranes makes it possible to achieve readily distinguishable measuring ranges on the torque-measuring flange.

Alternatively and cumulatively to a differing thickness of second measuring diaphragms, it is proposed that at least two measuring diaphragms exhibit a different shape. The latter can be produced both during a projection of the measuring diaphragm on a cylindrical surface around a measuring flange axis, or during a projection of the measuring diaphragm on a plane parallel to the measuring flange axis. This also makes it possible to achieve readily distinguishable expansion and/or stress behavior with a torque applied.

Identical measuring diaphragms are preferably arranged symmetrically relative to the rotational axis of the torque-measuring flange, in particular rotationally symmetrical. In such a configuration, the identically designed and symmetrically distributed measuring diaphragms can easily be used to verify the measured values of individual measured value transducers.

At least one measuring diaphragm can be partially cylindrical in design. In terms of the definition of a “partially cylindrical measuring diaphragm”, reference is made to the above explanations concerning a “partially cylindrical recess floor” of a measuring recess. Given a suitable configuration, the recess floor of a measuring recess is identical with the measuring diaphragm. Therefore, overall reference is made to the analogous description for a partially cylindrical recess floor with regard to a partially cylindrical measuring diaphragm.

Alternatively and cumulatively to a partial cylindrical measuring diaphragm, it is proposed that at least one measuring diaphragm deviate from a cylindrical shape, and preferably be flat. With respect to the geometric definition, let reference be made to the above explanations regarding a corresponding recess floor in this conjunction. Measured value transducers such as expansion measuring strips are especially simple to secure on a flat measuring diaphragm.

It is proposed that at least one measuring diaphragm exhibit an essentially constant thickness. In a measuring diaphragm embodied in this way, there are no extremely precise requirements as to where exactly on the measuring diaphragm a measured value transducer like an expansion-measuring strip must be affixed. This can make it easier to compare the values of different measured value transducers to each other.

At least one measuring diaphragm preferably has a circular shape.

With respect to terminology, let it be explained that a “circular shape” around the measuring flange axis can result in particular given a projection onto a plane parallel to the axis of torque-measuring flange or a radial projection onto a cylinder jacket-shaped projection surface. Precisely a measuring diaphragm that is circular relative to a can be easily incorporated into the measuring range through a borehole.

Let it be noted that the measuring diaphragm need not be “circular” in the exact mathematical sense of the word to realize this feature. It is also not necessary for the diaphragm to reflect the mathematical definition in the best possible physical approximation. Rather, it is already sufficient if at least essentially a circular shape exists, for example of the kind achieved when incorporating a conventional borehole into a metal work piece. In particular, a radius for a borehole diameter can fluctuate around the median value by about 10% and still be regarded as circular.

It is understood that, given numerous possible embodiments, it is difficult to define a border for the measuring diaphragm relative to a recess wall. If the wall passes over into the measuring diaphragm as an edge, the edge can be regarded as the defining border of the measuring diaphragm. In another aspect, a surface that remains uniform over a certain area in terms of curvature and thickness can be interpreted as the measuring diaphragm.

It is proposed that at least one measuring diaphragm be rectangular, in particular square, and preferably embodied with rounded corners. Such a form can also be produced relatively quickly.

A measured value transducer is preferably provided for each measuring diaphragm. A measured value transducer can advantageously be provided at each differently embodied or configured measuring diaphragm. Both facilitate the comparability, and hence the measuring accuracy, of the individual measured values at the torque-measuring flange.

At least one measuring diaphragm can be situated radially outward on the measuring range. A radially outward measuring diaphragm is able to absorb an applied torque with only a relatively slight force, since the measuring diaphragm has a greater lever radially outward relative to the axis of the torque-measuring flange.

In this way, a precise measurement can also take place for higher torques, or the diaphragm can be given a very thin design.

Possible measured value transducers include in particular expansion measuring strips and/or magnetic measured value transducers. Expansion measuring strips were referred to above in several examples. It is understood that these can be respectively replaced completely or in part by magnetic measured value transducers or other suitable measuring devices.

It is advantageous if at least one measured value transducer lying radially inward be arranged at the measuring area, in particular so as to be able to measure smaller torques well. Alternatively and cumulatively, it can be advantageous for at least one measured value transducer to be situated radially outward on the measuring range, in particular for measuring larger torques. A combination of radially inward and radially outward measured value transducers can be used very suitably for precisely acquiring torques in various ranges of magnitude.

It is understood that the measuring diaphragms or measuring recesses as well as the radially inward measuring recesses or radially outward measuring diaphragms can also be configured independently of the remaining features of the present invention in a manner advantageous for a torque-measuring flange.

The invention will be described in greater detail below based on an exemplary embodiment, drawing reference to the drawing. Shown on:

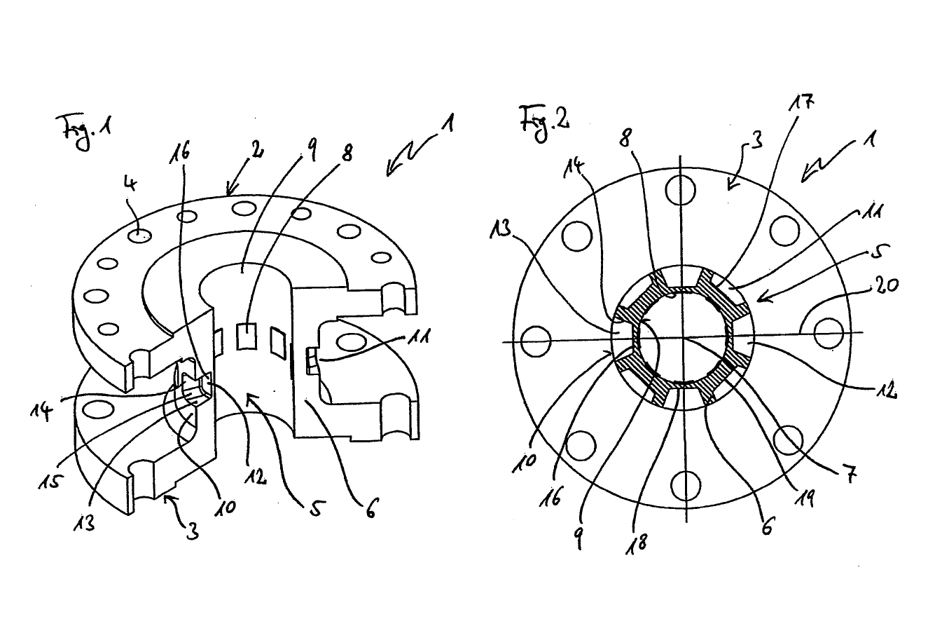

FIG. 1 is a diagrammatic depiction of a perspective view of a section measuring roughly two thirds of a torque-measuring flange with varyingly deep measuring recesses or varyingly thick measuring membranes, as well as

FIG. 2 is a diagrammatic section through a complete torque-measuring flange as embodied on FIG. 1, with a cutting plane at half the axial height of the torque-measuring flange from FIG. 1.

The torque-measuring flange 1 in the figures essentially consists of a pair of connecting flanges 2, 3, which are configures as annularly circular disks, and provided with boreholes 4 (exemplarily designated). Shafts or other parts of a machine or some other device are linked to the connecting flange 2, 3 via coupling boreholes 4, e.g., a torque-guiding shaft of a measuring bench.

The two connecting flanges 2, 3 of the torque-measuring flange 1 are designed as a single piece with a measuring range 5, wherein an essentially cylinder jacket shaped wall 6 of the torque-measuring flange 11 is designed as the “measuring range” 5.

If a torque around a rotational axis 7 of the torque-measuring flange 1 is applied to the connecting flange 2, 3 during operation of the torque-measuring flange, it is also applied in the measuring range 5, so that expansions and stresses arise in the cylindrical wall 6 of the measuring range 5, which permit conclusions as to the magnitude of the applied torque.

To be able to acquire these values, the torque-measuring flange 1 is equipped with a plurality of expansion-measuring strips 8 (exemplarily designated), which are all applied radially inward to a radially inward cylinder jacket-shaped surface 9 of the measuring range 5 or its cylinder wall 6. Specifically, eight expansion strips 8 are provided, namely distributed symmetrically around the rotational axis 7 of the torque-measuring flange 1.

Eight recesses are incorporated into the wall 6 of the measuring range 5 at a radially outward sheathing cylinder jacket surface 10, which lies coaxially with the inner surface 9, wherein four are flat recesses (exemplarily designated 11) and four are deep recesses (exemplarily designated 12).

The flat recesses 11 alternate with the deep recesses 12 in the outer surface 10 of the wall 6 of the measuring range 5, and each family—i.e., that of the flat recesses 11 or that of the deep recesses 12—is arranged in a rotationally symmetrical manner around the axes 7 of the torque-measuring flange 1.

Each recess 11, 12 has four respectively flat walls 13, 14 (exemplarily designated) with rounded grooves 15 (exemplarily designated) lying in between, as well as a flat recess floor 16, 17 (exemplarily designated).

Between the flat recess floor 16, 17 and the cylindrical interior surface 9 of the measuring range 5, relatively thin measuring diaphragms 18 (exemplarily designated) arise under the deep recesses 12 or relatively thick measuring diaphragms 19 (exemplarily designated) under the flat recesses 11.

The expansion measuring strips 8 are secured to the radial interior side of the measuring diaphragms 18, 19, radially concentric with each recess 11, 12. The expansion measuring strips are longer than the recesses 11, 12 in their axial extension. By contrast, the floor surfaces 16 of the recesses 11, 12 are wider than the expansion measuring strips 8 with respect to the tangential extension around the axis 7 of the torque-measuring flange 1.

The recesses 11, 12 in the measuring range 5 amplify deformations or stresses owing to an applied torque, so that measured value transducers 8 provided in the measuring range 5 can perform significantly more sensitive measurements. In this case, the recess floors 16, 17 or measuring diaphragms 18, 19 form locations that are correspondingly subjected to a greater stress or deformation.

The differing depths and varying areas between the flat measuring recesses 11 and the deep measuring recesses 12 give rise to areas in the measuring range 5 that react to different extents to the application of the torque, so that the torque-measuring flange 1 can exhibit several sensitivity ranges.

The advantage to the measuring diaphragms 18, 19 is that the measured value transducers 8 can essentially perform shear measurements, which can be conducted relatively precisely.

In particular, the cross section of a recess 11, 12 can be measured perpendicular to a recess depth to lie along an exemplarily designated central recess axis 20. In the case of radially oriented recesses in cylindrical measuring ranges, the cross section is preferably viewed on cylindrical surfaces situated around the rotational axis 7, or on a cutting plane parallel to the rotational axis 7. In the latter two cases, the depth is measured radially.

In this conjunction, the term “thickness of a measuring diaphragm” denotes the thickness of a measuring diaphragm, wherein the form of the measuring diaphragms is determined by its edges.

The exemplary embodiment does not show radially outward measuring diaphragms or radially inwardly opening measuring recesses, which can additionally increase the measuring accuracy for torque-measuring flanges, since larger deflections are encountered radially outward.

The reaction of the measuring diaphragms 18, 19 or measuring range 5 to an applied torque can be influenced by changing the cross sections of the recesses as a function of the depth 20 in the recess 11, 12. The recesses 11, 12 can expand or narrow in particular relative to the recess floor 16, 17, or exhibit walls 13, 14 that are not oriented or situated radially to the rotational axis and/or perpendicular oriented to the radius around the rotational axis and/or parallel to the rotational axis. Given a suitable selection of the cross sectional change, the stress signal and/or deformation of measuring diaphragms 18, 19, the recess floor 16 17 or other assemblies of the measuring range 5 can be enhanced, thereby making it possible to increase the sensitivity of the mechanical device, and hence the entire torque-measuring flange 1.

As directly evident, the measuring diaphragm in this exemplary embodiment exhibits a thickness that varies over its surface. This can be minimized in alternative exemplary embodiments by adjusting the floor of the measuring recesses to the opposing surface of the measuring range. In like manner, the opposing surface of the measuring range can also be correspondingly machined and adjusted to the floor of the respective measuring recess. In this way, the measuring diaphragms can essentially be given a flat, shell or cylindrical form, for example.

1. A torque-measuring flange with an essentially cylindrical measuring range, in which measuring recesses are arranged, and with measured value transducers, which measure stresses and/or deformations in the measuring range, wherein at least two measuring recesses are varyingly embodied.

2. The torque-measuring flange according to claim 1, wherein at least two measuring recesses exhibit different depths.

3. The torque-measuring flange according to claim 1, wherein at least two measuring recesses exhibit a different cross section.

4. The torque-measuring flange according to claim 1, wherein essentially identically embodied measuring recesses are symmetrically, preferably rotationally symmetrically, arranged relative to a rotational axis of the torque-measuring flange.

5. The torque-measuring flange according to claim 1, wherein at least one measuring recess exhibits an essentially partially cylindrical recess floor.

6. The torque-measuring flange according to claim 1, wherein at least one measuring recess exhibits a recess floor that deviates from the cylindrical form, preferably a flat recess floor.

7. The torque-measuring flange according to claim 1, wherein at least one measuring recess exhibits a recess floor with a surface corresponding to the surface of the cylindrical measuring range, toward which the measuring recess is oriented.

8. The torque-measuring flange according to claim 1, wherein at least one measuring recess exhibits a round cross section.

9. The torque-measuring flange according to claim 1, wherein at least one measuring recess exhibits a rectangular, even square, cross section with rounded corners.

10. The torque-measuring flange according to claim 1, wherein a measured value transducer is provided for each measuring recess.

11. The torque-measuring flange according to claim 1, wherein at least one measuring recess opens radially inward.

12. The torque-measuring flange according to claim 1, wherein at least one measuring recess changes proceeding from the recess floor, preferably expands or narrows.

13. A torque-measuring flange with a measuring range arranged around a rotational axis, in which measuring diaphragms are arranged, and with measured value transducers, which measure stresses and/or deformations in the measuring diaphragms, wherein at least two measuring diaphragms are varyingly embodied.

14. The torque-measuring flange according to claim 13, wherein at least two measuring diaphragms exhibit a different thickness.

15. The torque-measuring flange according to claim 13, wherein at least two measuring diaphragms exhibit a different shape.

16. The torque-measuring flange according to claim 13, wherein identical measuring diaphragms are symmetrically, preferably rotationally symmetrically, arranged relative to the rotational axis.

17. The torque-measuring flange according to claim 13, wherein at least one measuring diaphragm is partially cylindrical.

18. The torque-measuring flange according to claim 13, wherein at least one measuring diaphragm deviates from the cylindrical form, and preferably is flat.

19. The torque-measuring flange according to claim 13, wherein at least one measuring diaphragm exhibits an essentially constant thickness.

20. The torque-measuring flange according to claim 13, wherein at least one measuring diaphragm is circular.

21. The torque-measuring flange according to claim 13, wherein at least one measuring diaphragm is rectangular, even square, and embodied with rounded corners.

22. The torque-measuring flange according to claim 13, wherein a measured value transducer is provided for each measuring diaphragm.

23. The torque-measuring flange according to claim 13, wherein at least one measuring diaphragm is arranged radially outward on the measuring range.

24. The torque-measuring flange according to claim 1, wherein the measured value transducers encompass expansion-measuring strips.

25. The torque-measuring flange according to claim 1, wherein the measured value transducers encompass magnetic measured value transducers.

26. The torque-measuring flange according to claim 1, wherein at least one measured value transducer is arranged radially inward on the measuring range.

27. The torque-measuring flange according to claim 1, wherein at least one measured value transducer is arranged radially outward on the measuring range.
